(19) United States
(12) Patent Application Publication
(10) Pub. No.: US 2026/0006173 A1
(43) Pub. Date: Jan. 1, 2026

(54) VIDEO MONITORING DEVICE AND VIDEO MONITORING METHOD

(71) Applicant: Nuvoton Technology Corporation Japan, Kyoto (JP)

(72) Inventors: Koichi FURUTANI, Kyoto (JP); Masayasu MUKAI, Kyoto (JP)

(21) Appl. No.: 19/322,072

(22) Filed: Sep. 8, 2025

Related U.S. Application Data
(63) Continuation of application No. PCT/JP2024/005410, filed on Feb. 16, 2024.

(30) Foreign Application Priority Data
Mar. 22, 2023 (JP) 2023-045537

(51) Int. Cl. H04N 17/02; G06V 10/50; G06V 10/56; G06V 10/60; G06V 20/40

(52) U.S. Cl. CPC H04N 17/02; G06V 10/50; G06V 10/56; G06V 10/60; G06V 20/46

(57) ABSTRACT

A video monitoring device that monitors video data received from a video display device that receives a video signal from a camera and displays a video, the video monitoring device including: a video extractor that extracts, from the video data, color information of each pixel in an image indicated by the video data; a specific color difference operator that computes, for each pixel, difference information between a color indicated by the color information and a predetermined specific color; a histogram calculator that calculates a histogram by classifying the difference information computed for each pixel, the histogram having, for each difference interval, a frequency indicating the number of pixels belonging to the difference interval; and an anomaly detector that generates and outputs a signal indicating that the video data is anomalous, when a frequency of belonging to a predetermined difference interval in the histogram is at least a first threshold.

### CROSS REFERENCE TO RELATED APPLICATIONS

This is a continuation application of PCT International Patent Application No. PCT/JP2024/005410 filed on Feb. 16, 2024, designating the United States of America, which is based on and claims priority of Japanese Patent Application No. 2023-045537 filed on Mar. 22, 2023. The entire disclosures of the above-identified applications, including the specifications, drawings and claims are incorporated herein by reference in their entirety.

### FIELD

The present disclosure relates to a video monitoring device and a video monitoring method.

### BACKGROUND

Patent Literature (PTL) 1 discloses a technique for determining various acts of interference with a monitoring camera. More specifically, PTL 1 compares a video captured by a monitoring camera and a reference video held by a memory, calculates a luminance difference for each pixel, extracts, as a changed pixel, a pixel whose luminance difference is at least a first threshold and counts the changed pixels, and detects a sudden change in the video, thereby determining various acts of interference with the monitoring camera based on whether such a changed pixel and a sudden change exist in the video. PTL 2 discloses a technique for determining that a video is frozen. More specifically, PTL 2 continuously obtains, as an inspection video, a video continuously acquired from the outside or a video continuously generated based on the video continuously acquired from the outside, and then calculates a sum total of pixel values of all the pixels of the inspection image obtained, to calculate the difference between two sum totals calculated by a sum total calculator from a previously obtained inspection image and the currently obtained inspection image, thereby determining that a video is frozen based on the difference detected for a predetermined number of times in a row. PTL 3 discloses holding specific objects in association with a plurality of color identifiers, and, according to the luminance of target portions present in a detection region, setting color identifiers to the target portions in accordance with the luminance of the target portions based on the association between color identifiers and the luminance range, and grouping the color identifiers, thereby determining which color identifier is anomalous.

### CITATION LIST

### Patent Literature

PTL 1: Japanese Unexamined Patent Application Publication No. 2008-077517
PTL 2: Japanese Unexamined Patent Application Publication No. 2009-278340
PTL 3: Japanese Unexamined Patent Application Publication No. 2012-238244

### SUMMARY

### Technical Problem

According to the conventional techniques disclosed in PTL 1, PTL 2, and PTL 3, it is possible to detect each video anomaly by calculating, for a particular region, a sum total of pixel values based on the luminance information; however, since only the luminance information is extracted, only the sum total and the feature of the video's brightness and darkness can be extracted. As a consequence, only simple video anomalies such as black fixed video can be detected.

The present disclosure provides a video monitoring device and a video monitoring method that can avoid a video anomaly attributable to various colors, such as obstruction of the driver's vision due to an anomalous color caused by ambient light.

### Solution to Problem

A video monitoring device according to an aspect of the present disclosure is a video monitoring device that monitors video data received from a video display device that receives a video signal from a camera and displays a video, the video monitoring device including: a video extractor that extracts, from the video data received, color information of each of pixels included in an image indicated by the video data; a specific color difference operator that computes, for each of the pixels, difference information indicating a difference between a color indicated by the color information extracted and a specific color that is predetermined; a histogram calculator that calculates a histogram by classifying the difference information computed for each of the pixels, the histogram having, for each of a plurality of difference intervals, a frequency indicating a total number of pixels that belong to the difference interval; and an anomaly detector that generates and outputs a signal indicating that the video data is anomalous, when a frequency of belonging to a predetermined difference interval in the histogram calculated is at least a first threshold.

A video monitoring method according to an aspect of the present disclosure is a video monitoring method for monitoring video data received from a video display device that receives a video signal from a camera and displays a video, the video monitoring method including: extracting, from the video data received, color information of each of pixels included in an image indicated by the video data; computing, for each of the pixels, difference information indicating a difference between a color indicated by the color information extracted and a specific color that is predetermined; calculating a histogram by classifying the difference information computed for each of the pixels, the histogram having, for each of a plurality of difference intervals, a frequency indicating a total number of pixels that belong to the difference interval; and generating and outputting a signal indicating that the video data is anomalous, when a frequency of belonging to a predetermined difference interval in the histogram calculated is at least a first threshold.

### Advantageous Effects

The video monitoring device and the video monitoring method according to an aspect of the present disclosure can avoid a video anomaly attributable to various colors, such as obstruction of the driver's vision due to an anomalous color caused by ambient light, and thus, more types of anomalies can be monitored in the video display.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a configuration of a video monitoring device according to a reference example.

FIG. 2 is a flowchart illustrating a video monitoring method performed by a video monitoring device according to a reference example.

FIG. 3 is a conceptual diagram of an example of a histogram calculation method according to a reference example.

FIG. 4 is a conceptual diagram illustrating an example of an anomaly detection method according to a reference example.

FIG. 5 is a conceptual diagram illustrating video anomalies of a head-up display according to a reference example.

FIG. 6 is a block diagram illustrating a configuration of a video monitoring device according to an embodiment.

FIG. 7 is a flowchart illustrating a video monitoring method performed by a video monitoring device according to an embodiment.

FIG. 8 is a conceptual diagram of a histogram calculation method according to an embodiment.

FIG. 9 is a conceptual diagram illustrating a video monitoring method according to an embodiment.

### DESCRIPTION OF EMBODIMENT

In recent years, functional safety support for video processing has become mandatory in video display devices for in-vehicle head-up displays. Accordingly, there is a need for a mechanism that determines whether a video signal is anomalous or not. The conventional techniques can detect each video anomaly by calculating, for a particular region, a sum total of pixel values based on luminance information; however, since only the luminance information is extracted, only the sum total and the feature of the video's brightness and darkness can be extracted, meaning that it may not be possible to avoid an anomaly in the video information or a video anomaly attributable to various colors such as obstruction of the driver's vision due to ambient light. That is to say, the conventional techniques can only detect simple video anomalies such as black fixation.

In view of the above, the present disclosure provides a video monitoring device and a video monitoring method that can avoid a video anomaly attributable to various colors, such as obstruction of the driver's vision due to an anomalous color caused by ambient light.

To achieve the above, for example, a video monitoring device according to technique 1 of the present disclosure is a video monitoring device that monitors video data received from a video display device that receives a video signal from a camera and displays a video, the video monitoring device including: a video extractor that extracts, from the video data received, color information of each of pixels included in an image indicated by the video data; a specific color difference operator that computes, for each of the pixels, difference information indicating a difference between a color indicated by the color information extracted and a specific color that is predetermined; a histogram calculator that calculates a histogram by classifying the difference information computed for each of the pixels, the histogram having, for each of a plurality of difference intervals, a frequency indicating a total number of pixels that belong to the difference interval; and an anomaly detector that generates and outputs a signal indicating that the video data is anomalous, when a frequency of belonging to a predetermined difference interval in the histogram calculated is at least a first threshold.

With this, the video monitoring device can directly receive video data and detect a video anomaly, and can be implemented with low latency without having to obtain the video data via a memory. In addition, with the video extractor and the specific color difference operator, a video anomaly can be detected by extracting, for example, the sum total and the feature of the color information such as RGB or YUV other than the video's brightness and darkness. Therefore, the video monitoring device can avoid a video anomaly attributable to various colors, such as obstruction of the driver's vision due to an anomalous color caused by ambient light, and thus, more types of anomalies can be monitored in the video display.

Here, a video monitoring device according to technique 2 is the video monitoring device according to technique 1, further including: a signal determiner that determines, for each of the pixels, whether the pixel belongs to a video monitoring region that is a region to be monitored, in which the histogram calculator calculates the histogram for a pixel determined by the signal determiner to belong to the video monitoring region. With this, a video anomaly can be detected with a focus only on the video monitoring region, and thus, high-speed detection becomes possible.

In addition, a video monitoring device according to technique 3 is the video monitoring device according to technique 1 or 2, further including: a luminance extractor that extracts, from the video data received, luminance information of each of the pixels included in the image indicated by the video data; and an extracted component selector that selects the luminance information extracted by the luminance extractor or the difference information computed by the specific color difference operator, in which the histogram calculator calculates the histogram based on the luminance information or the difference information selected by the extracted component selector. With this, it is possible to selectively perform the detection of a video anomaly based on the luminance information as in the conventional techniques and the detection of a video anomaly attributable to various colors.

In addition, a video monitoring device according to technique 4 is the video monitoring device according to any one of techniques 1 to 3, in which, for example, the video data includes, for each of the pixels, data items on RGB or YUV components, the specific color includes data items on RGB or YUV components, and the specific color difference operator takes a difference between the video data and the specific color, for each of the data items on RGB or YUV components.

With this, even in the case of taking the difference with respect to the RGB or YUV reference color information extracted, the video monitoring device can perform the determination without using many operators and thus can achieve hardware reduction, by reducing the amount of the difference information from 8×3=24 bits to 8 bits.

In addition, a video monitoring device according to technique 5 is the video monitoring device according to any one of techniques 1 to 4, in which, for example, the signal determiner determines, for each of the pixels, whether the pixel belongs to the video monitoring region, by using an intermediate video data item selected from among a plurality of intermediate video data items generated in a process of generating the video data on a path from the camera to the video display device.

With this, since the video monitoring device determines whether the pixel belongs to the video monitoring region by using one intermediate video data item selected from among a plurality of intermediate video data items resulting from a plurality of video processes, the video monitoring region can be determined from intermediate video data different from the video data input to the video extractor, and a video anomaly can be detected in various types of video processing systems.

In addition, a video monitoring device according to technique 6 is the video monitoring device according to any one of techniques 1 to 5, in which, for example, the histogram calculator has a plurality of first thresholds each being the first threshold, and calculates the histogram based on a first threshold selected from among the plurality of first thresholds.

With this, since the video monitoring device can calculate the tendency of the stepwise difference result through the histogram based on the first threshold selected from among the plurality of first thresholds, it is possible to adjust the condition for video anomaly detection depending on the characteristics of the target video processing system.

In addition, for example, a video monitoring device according to technique 7 of the present disclosure is the video monitoring device according to any one of techniques 1 to 6, in which the video data is a moving image, and the anomaly detector determines, for each of frames included in the moving image, whether the frequency of belonging to the predetermined difference interval in the histogram is at least the first threshold, and generates and outputs a signal indicating that the video data is anomalous when a total number of consecutive frames for which the frequency of belonging to the predetermined difference interval in the histogram is determined to be at least the first threshold, is at least a second threshold.

With this, by setting, as the determination criterion, a total number of detections of an anomaly in units of frames, the video monitoring device can, in the determination of a video anomaly, reduce the probability of erroneous determination and achieve precise determination.

In addition, a video monitoring device according to technique 8 is the video monitoring device according to technique 7, in which the second threshold is a variable value. With this, it is possible to adjust the threshold for the total number of consecutive frames with a sign of a video anomaly, and it is therefore possible to adjust the condition for video anomaly detection depending on the noise environment of the target video processing system.

In addition, a video monitoring method according to technique 9 of the present disclosure is a video monitoring method for monitoring video data received from a video display device that receives a video signal from a camera and displays a video, the video monitoring method including: extracting, from the video data received, color information of each of pixels included in an image indicated by the video data; computing, for each of the pixels, difference information indicating a difference between a color indicated by the color information extracted and a specific color that is predetermined; calculating a histogram by classifying the difference information computed for each of the pixels, the histogram having, for each of a plurality of difference intervals, a frequency indicating a total number of pixels that belong to the difference interval; and generating and outputting a signal indicating that the video data is anomalous, when a frequency of belonging to a predetermined difference interval in the histogram calculated is at least a first threshold.

With this, with the video extraction and the specific color difference computation, a video anomaly can be detected by extracting, for example, the sum total and the feature of the color information such as RGB or YUV other than the video's brightness and darkness. Therefore, the video monitoring method can avoid a video anomaly attributable to various colors such as obstruction of the driver's vision due to an anomalous color caused by ambient light, and thus, more types of anomalies can be monitored in the video display.

Hereinafter, with reference to the Drawings, a video monitoring device according to a reference example provided for explaining an object of the present application will be described, and after that, a video monitoring device according to an embodiment which can achieve an object of the present application will be described. Note that the reference example and the embodiment described below each show a general or specific example. The numerical values, shapes, materials, constituent elements, the arrangement and connection of the constituent elements, steps, the processing order of the steps etc. shown in the following reference example and embodiment are mere examples, and therefore do not intend to limit the scope of the claims.

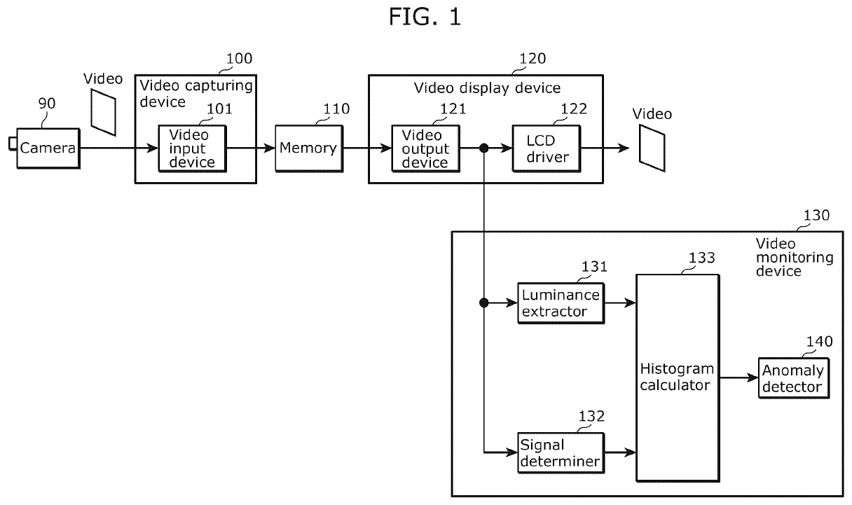

FIG. 1 is a block diagram illustrating a configuration of video monitoring device 130 according to a reference example. Note that this diagram also illustrates a video processing system (that is, camera 90, video capturing device 100, memory 110, and video display device 120) to be monitored by video monitoring device 130. Video capturing device 100 illustrated in FIG. 1 includes video input device 101, decodes, using video input device 101, video imported from camera 90, and transmits the decoded video to memory 110 in units of lines. Here, a video is composed of a plurality of pixels such as RGB pixels.

Memory 110 imports and temporarily holds the video decoded by video capturing device 100.

Video display device 120 is, for example, an in-vehicle head-up display, and includes video output device 121 and liquid crystal display (LCD) driver 122. Video output device 121 performs video output processing on the video that has been read from memory 110, and LCD driver 122 converts the resulting video into a video appropriate to an interface used for outputting an LCD video, and transmits the converted video to an LCD (not illustrated). Here, the video transmitted to the LCD (not illustrated) is also composed of a plurality of pixels such as RGB pixels.

Video monitoring device 130 is a device that monitors video data received from video display device 120 that receives a video signal from camera 90 and displays a video. Video monitoring device 130 includes luminance extractor 131, signal determiner 132, histogram calculator 133, and anomaly detector 140. For example, these constituent elements are electric circuits. To be more specific, these constituent elements are implemented as, for example, logic circuits including semiconductors or processors that perform processing according to a program.

Video monitoring device 130 draws in intermediate video data that is output from video output device 121 of video display device 120, and monitors the video state. Note that in the present Specification, the video data is also simply referred to as a “video”. Also, the video data generated during the process, performed on the path from camera 90 to video display device 120, of generating video data that is eventually transmitted from video display device 120 to the LCD (not illustrated) is also referred to as “intermediate video data”.

In the present reference example, the intermediate video data that video monitoring device 130 draws in from video display device 120 is transmitted in units of lines and is composed of pixels of luminance components only.

In synchronization with signal determiner 132, luminance extractor 131 extracts luminance information in units of lines from the intermediate video data drawn in from video display device 120.

Note that the intermediate video data that is input to luminance extractor 131 is not limited to the intermediate video data generated by being subjected to any of a plurality of video processes performed on the path from camera 90 to video display device 120, and can also be drawn in from a plurality of video regions in the same frame. In the present reference example, intermediate video data generated in video display device 120 is drawn into luminance extractor 131.

From the intermediate video data that has been drawn in, signal determiner 132 determines, for each of the pixels, whether the pixel belongs to a video monitoring region that is a region to be monitored (that is, obtains an extraction region). This processing is performed in synchronization with the extraction, by luminance extractor 131, of the luminance information from the intermediate video data.

Note that the intermediate video data that is input to signal determiner 132 is not limited to the intermediate video data generated by being subjected to any of a plurality of video processes performed on the path from camera 90 to video display device 120, and can also be drawn in from a plurality of video regions in the same frame. In the present reference example, intermediate video data generated in video display device 120 is drawn into signal determiner 132.

Histogram calculator 133 calculates a histogram by classifying, for each of the pixels, the luminance information extracted by luminance extractor 131. Here, the histogram has, for each of a plurality of luminance intervals, a frequency indicating a total number of pixels that belong to the luminance interval. In the present reference example, for the video data (that is, the luminance information) extracted by luminance extractor 131, when a pixel is determined by signal determiner 132 to belong to the video monitoring region, histogram calculator 133 has a plurality of certain thresholds for the luminance information, calculates, based on the thresholds, a histogram indicating the frequency of pixels belonging to each luminance interval, and transmits the calculated histogram result to anomaly detector 140.

With this, the tendency of the stepwise difference result is calculated for the luminance information, and thus it is possible to perform precise determination regarding a luminance anomaly of the video data, based on a rate at which the luminance information to be extracted is present in a designated video region.

Anomaly detector 140 monitors, in units of frames, the information on the histogram result transmitted from histogram calculator 133, and when an anomalous tendency is detected for several frames in a row, determines eventually that a video anomaly is occurring and informs an external central processing unit (CPU) or engine control unit (ECU) (both are not illustrated) that an anomaly has occurred. Here, the “anomalous tendency” is that in the histogram calculated by histogram calculator 133, the frequency of belonging to a predetermined interval is at least a threshold. It suffices so long as there is at least one predetermined interval. When there are two or more predetermined intervals, a threshold for the anomaly determination may be provided for each interval.

With this, by setting, as the determination criterion, a total number of consecutive detections of an anomaly in units of frames, it is possible, in the determination of a video anomaly, to reduce the probability of erroneous determination and achieve precise determination.

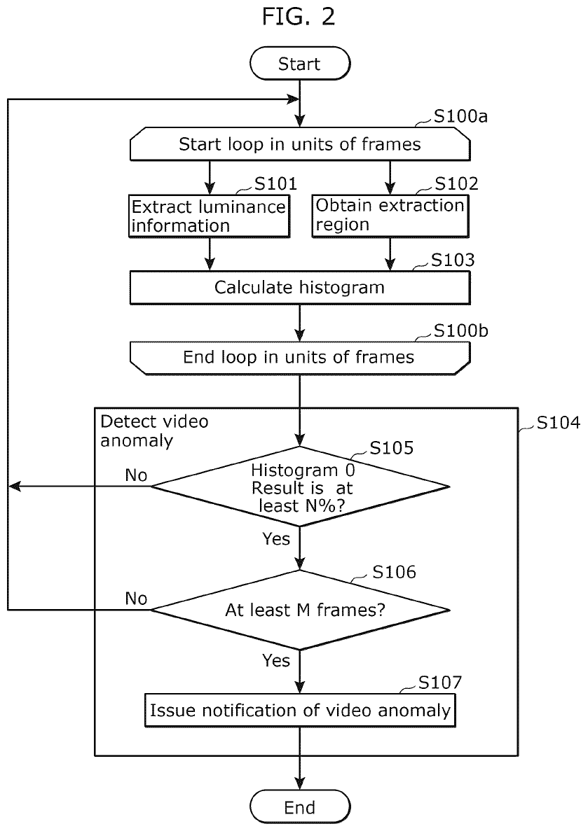

FIG. 2 is a flowchart illustrating operation of video monitoring device 130 illustrated in FIG. 1. First, loop processing is performed in units of frames (100a through 100b). In the loop processing, first, luminance information extraction by luminance extractor 131 (S101) and extraction region obtainment by signal determiner 132 (S102) are performed in synchronization in real time.

Next, the luminance information extracted is subjected to histogram calculation (S103) only when the extraction region is valid in units of pixels (that is, only when the pixel belongs to the video monitoring region). Here, the histogram in this example is calculated in 16 segments for the luminance information, and the range of the histogram is set from 0 to 15 in ascending order. The histogram is calculated in 16 segments having thresholds for the luminance information. For example, in the case of extracting a histogram for the lowest luminance, it is determined that the video contains a large quantity of information having the lowest luminance when histogram 0, among histograms 0 to 15, indicates a frequency greater than or equal to a threshold, whereas in the case of extracting a histogram for the highest luminance, it is determined that the video contains a large quantity of information having the highest luminance when histogram 15, among histograms 0 to 15, indicates a frequency greater than or equal to a threshold. That is to say, the target video data is a black image video when information having the lowest luminance is contained in a large quantity, whereas the target video data is a white image video when information having the highest luminance is contained in a large quantity.

When the above loop processing performed in units of frames is finished, anomaly detector 140 performs video anomaly detection (S104). Here, assuming that a video containing a large quantity of information having the lowest luminance is an example of a video having an anomalous tendency, when the frequency of belonging to histogram 0 is at least N % of the histogram calculation result for the entire luminance information (that is, all the frequencies) (Yes in S105), it means that a black image video having an anomalous tendency has been detected, whereas when the frequency is less than N % (No in S105), it means that a black image video having an anomalous tendency was not detected. Note that N for N % is a given integer and can be variable as a threshold.

After the determination in the histogram calculation, when the case where the frequency is at least N % of the histogram calculation result (Yes in S105) continues for at least M frames in a row (Yes in S106), anomaly detector 140 determines that the black image video is continuing (that is, a video anomaly is occurring) and notifies the outside that a video anomaly has occurred (S107). On the other hand, when such a case continues for less than M frames (No in S106), the loop processing performed in units of frames is continued (100a through 100b). Note that M for M frames is a given integer and can be variable as a threshold.

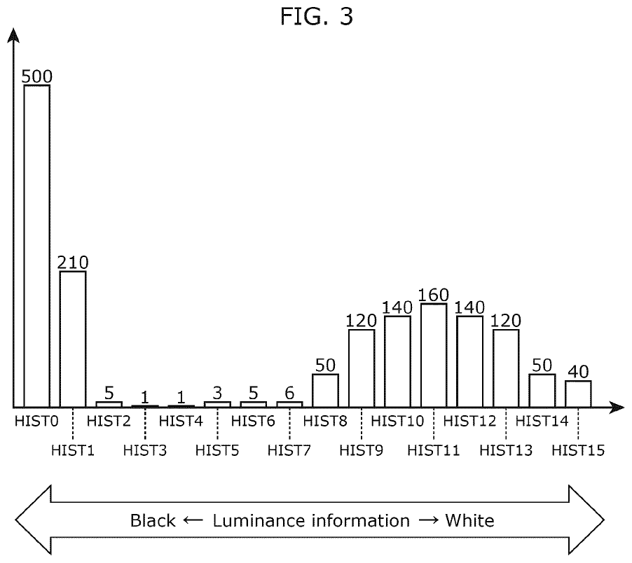

FIG. 3 is a conceptual diagram illustrating an example of a histogram calculation method used by histogram calculator 133. Described here is an example in which the histogram is calculated in 16 segments. That is to say, a histogram having the luminance information on the horizontal axis is calculated in 16 segments having thresholds. For example, in the case of extracting a histogram for the lowest luminance, the target video data is determined to be a video containing a large quantity of information having the lowest luminance when histogram 0, among histograms 0 to 15, indicates a frequency greater than or equal to a threshold, whereas in the case of extracting a histogram for the highest luminance, the target video data is determined to be a video containing a large quantity of information having the highest luminance when histogram 15, among histograms 0 to 15, indicates a frequency greater than or equal to a threshold. That is to say, the target video data is a black image video when information having the lowest luminance is contained in a large quantity, whereas the target video data is a white image video when information having the highest luminance is contained in a large quantity.

Note that the histogram need not necessarily be calculated for the entire video monitoring region obtained by signal determiner 132, and may be calculated for only the ½, ¼, or ⅛ pixels of the video monitoring region. Also, although described above is an example in which the histogram has 16 segments on the horizontal axis, the histogram may have 32 segments for a higher detection precision.

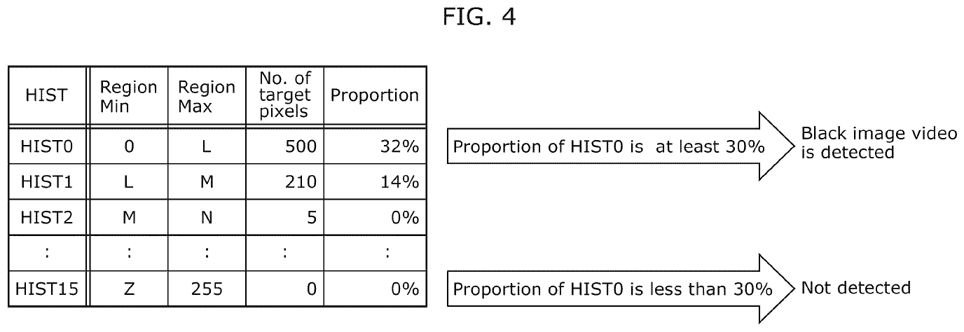

FIG. 4 is a conceptual diagram illustrating an example of an anomaly detection method performed by anomaly detector 140. Described here is an example in which the histogram is calculated in 16 segments. The histogram obtained by histogram calculator 133 is put into a table (that is, categorized into HIST0 through HIST15 into which the luminance information is categorized according to “Region Min” to “Region Max”), and since histogram 0 (“HIST0”) occupies, for example, at least 30% (“32%” in the diagram), it is determined that the video contains a large quantity of information having the lowest luminance and that a black image video has been detected.

Note that if histogram 15 (“HIST15”) occupies, for example, at least 30%, it is determined that the video contains a large quantity of information having the highest luminance and that a white image video has been detected. In the present reference example, histogram 15 (“HIST15”) occupies 0%, and thus it is determined that a white image video was not detected (“Not detected”).

After the determination in the histogram calculation, it is eventually determined that the black or white image video is continuing (that is, a video anomaly is occurring) when the case where the proportion is at least 30% of the histogram calculation result continues for at least 10 frames in a row. Otherwise, the monitoring is continued.

Note that the threshold for the anomaly need not necessarily be at least 30%, and may be variable according to the application.

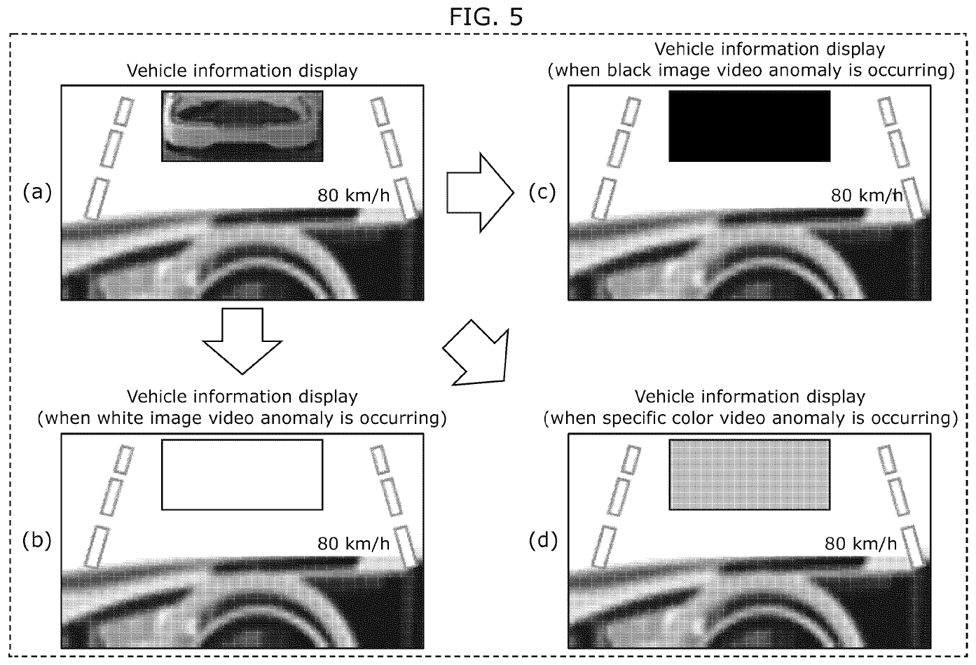

FIG. 5 is a conceptual diagram illustrating a white image video, a black image video, and a specific color video as examples of a video anomaly that occurs when an in-vehicle head-up display is used. Part (a) of FIG. 5 illustrates an example of normal vehicle information display, part (b) of FIG. 5 illustrates an example of anomalous vehicle information display showing a white image video, part (c) of FIG. 5 illustrates an example of anomalous vehicle information display showing a black image video, and part (d) of FIG. 5 illustrates an example of anomalous vehicle information display showing a specific color video.

Since video monitoring device 130 according to the present reference example extracts only the luminance information, only the histogram representing the video's brightness and darkness can be extracted. Specifically, when the video information becomes anomalous due to some influence, it is only possible to detect the anomaly by detecting the white image video (part (b) of FIG. 5) and the black image video (part (c) of FIG. 5). Therefore, when, for example, ambient light (yellow light or orange light, for example) during driving of a vehicle makes the video on the head-up display appear in an anomalous color and not easy to view, hindering the driver's driving (part (d) of FIG. 5), video monitoring device 130 according to the present reference example cannot detect the video anomaly.

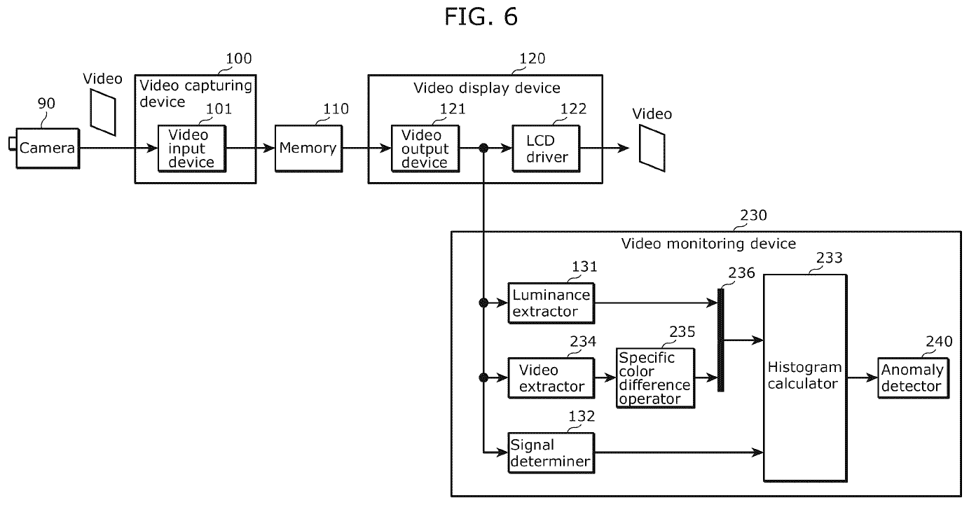

FIG. 6 is a block diagram illustrating a configuration of video monitoring device 230 according to the present embodiment. Note that this diagram also illustrates a video processing system (that is, camera 90, video capturing device 100, memory 110, and video display device 120) to be monitored by video monitoring device 230. The constituent elements of the video processing system are the same as those illustrated in FIG. 1. Hereinafter, the same constituent elements as those of the reference example illustrated in FIG. 1 are given identical reference signs, and the descriptions thereof are simplified or omitted. The following description focuses on constituent elements different from the constituent elements according to the reference example illustrated in FIG. 1.

Video monitoring device 230 is a device that monitors video data received from video display device 120 that receives a video signal from camera 90 and displays video. Video monitoring device 230 includes luminance extractor 131, signal determiner 132, histogram calculator 233, video extractor 234, specific color difference operator 235, extracted component selector 236, and anomaly detector 240. For example, these constituent elements are electric circuits. To be more specific, these constituent elements are implemented as, for example, logic circuits including semiconductors or processors that perform processing according to a program.

Video monitoring device 230 draws in intermediate video data that is output from video output device 121 of video display device 120, and monitors the video state.

In the present embodiment, the intermediate video data that video monitoring device 230 draws in from video display device 120 is transmitted in units of lines and composed of pixels of RGB or YUV components.

In synchronization with signal determiner 132, luminance extractor 131 extracts luminance information in units of lines from the intermediate video data drawn in from video display device 120.

Note that the intermediate video data that is input to luminance extractor 131 is not limited to the intermediate video data generated by being subjected to any of a plurality of video processes performed on the path from camera 90 to video display device 120, and can also be drawn in from a plurality of video regions in the same frame. In the present embodiment, intermediate video data generated in video display device 120 is drawn into luminance extractor 131.

Video extractor 234 extracts, from the intermediate video data drawn in from video display device 120, color information of each of the pixels included in an image indicated by the video data (that is, performs video information extraction). Specifically, video extractor 234 performs the video information extraction in units of lines in synchronization with signal determiner 132. For example, video extractor 234 extracts RGB or YUV components from the intermediate video data.

Note that the intermediate video data that is input to video extractor 234 is not limited to the intermediate video data generated by being subjected to any of the plurality of video processes performed on the path from camera 90 to video display device 120, and can also be drawn in from a plurality of video regions in the same frame. In the present embodiment, intermediate video data generated in video display device 120 is drawn into video extractor 234.

Specific color difference operator 235 computes, for each of the pixels, a difference between a color indicated by the color information extracted by video extractor 234 and a predetermined specific color, as difference information. That is to say, specific color difference operator 235 calculates the difference with respect to the specific color (that is, a reference video) for each of the pixels including RGB or YUV components extracted by video extractor 234. Specifically, assuming an example where each pixel includes RGB components and when, for a given pixel, the specific color (that is, the reference video) is composed of Rs, Gs, and Bs and the color information extracted by video extractor 234 is Ri, Gi, and Bi, the difference value is calculated by ABS (Rs−Ri)+ABS (Gs−Gi)+ABS (Bs−Bi)>>2. Here, ABS means an absolute value. Also, “>>2” means to shift in the right direction by 2 bits.

As described above, in the case of taking, for each of data items on RGB or YUV components, the difference between the video data and the specific color to take the difference between the color information extracted and the reference color information, specific color difference operator 235 can perform the determination without using many operators and thus can achieve hardware reduction, by reducing the amount of the difference information from 8×3=24 bits to 8 bits.

From the intermediate video data that has been drawn in, signal determiner 132 determines, for each of the pixels, whether the pixel belongs to a video monitoring region that is a region to be monitored (that is, performs extraction region obtainment). This processing is performed in synchronization with the extraction, by luminance extractor 131, of the luminance information from the intermediate video data and the extraction, by video extractor 234, of the color information from the intermediate video data.

Extracted component selector 236 selects the luminance information extracted by luminance extractor 131 or the difference information computed by specific color difference operator 235. For example, extracted component selector 236 selects the luminance information or the difference information based on a control signal provided from an external CPU or the like.

Note that the intermediate video data that is input to signal determiner 132 is not limited to the intermediate video data generated by being subjected to any of a plurality of video processes performed on the path from camera 90 to video display device 120, and can also be drawn in from a plurality of video regions in the same frame. In the present embodiment, intermediate video data generated in video display device 120 is drawn into signal determiner 132.

Histogram calculator 233 calculates a histogram by classifying, for each of the pixels, the luminance information or the difference information selected by extracted component selector 236. Here, the histogram has, for each of a plurality of luminance intervals or difference intervals, a frequency indicating a total number of pixels that belong to the luminance interval or the difference interval. In the present embodiment, for the luminance information or the difference information selected by extracted component selector 236, when a pixel is determined by signal determiner 132 to belong to the video monitoring region, histogram calculator 233 has a plurality of certain thresholds for the luminance information or the difference information, calculates, based on the thresholds, a histogram indicating, for each luminance interval or difference interval, the frequency of pixels belonging to the luminance interval or difference interval, and transmits the calculated histogram result to anomaly detector 240.

With this, it is possible to calculate a tendency of the stepwise difference result for the difference information with respect to a specific color, and perform precise determination regarding an anomaly in relation to the specific color of the video data, based on a rate at which the difference information to be extracted is present in a designated video region.

Anomaly detector 240 monitors, in units of frames, the information on the histogram result transmitted from histogram calculator 233, and when an anomalous tendency is found for several frames in a row, determines that an anomaly is occurring and notifies an external CPU or ECU (both are not illustrated) that an anomaly has occurred. Here, the “anomalous tendency” is that in the histogram calculated by histogram calculator 233, the frequency of belonging to a predetermined interval is at least a threshold. It suffices so long as there is at least one predetermined interval. When there are two or more predetermined intervals, a threshold for the anomaly determination may be provided for each of the predetermined intervals.

With this, by setting, as the determination criterion, a total number of detections of an anomaly in units of frames, it is possible, in the determination of a video anomaly, to reduce the probability of erroneous determination and achieve precise determination.

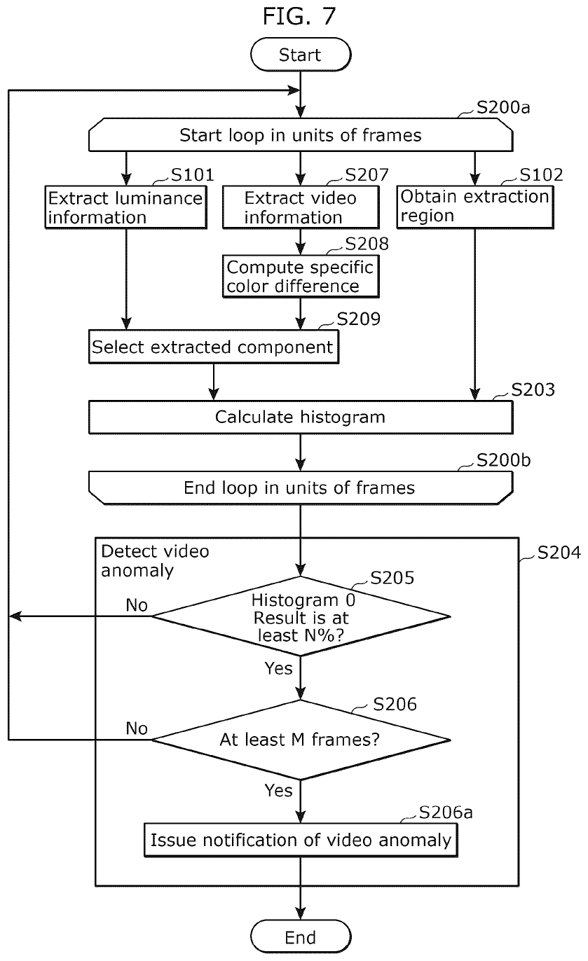

FIG. 7 is a flowchart illustrating operation of video monitoring device 230 illustrated in FIG. 6. The same processing steps as those in the flowchart according to the reference example illustrated in FIG. 2 are given the same reference signs as those in FIG. 2.

First, loop processing is performed in units of frames (200a through 200b). In the loop processing, luminance information extraction by luminance extractor 131 (S101), video information extraction by video extractor 234 (video extraction S207), and extraction region obtainment by signal determiner 132 (S102) are performed in synchronization in real time. In video extraction S207, in more detail, video extractor 234 extracts, from the intermediate video data drawn in from video display device 120, color information of each of the pixels included in an image indicated by the video data.

For each of the pixels of the video data including RGB or YUV components extracted in the video information extraction (S207), specific color difference operator 235 calculates the difference from a specific color (that is, a reference video) as difference information (specific color difference computation S208).

Extracted component selector 236 selects the luminance information extracted by luminance extractor 131 or the difference information including RGB or YUV components and computed by specific color difference operator 235 (S209). Note that this is a mere example, and all of (that is, both of) the luminance information and the difference information including RGB or YUV components may be selected while being switched from one to the other.

Subsequently, for the luminance information or the difference information selected, histogram calculator 233 performs histogram calculation (histogram calculation S203) only when signal determiner 132 determines that the extraction region is valid (that is, only when the target pixel is determined to belong to the video monitoring region). Here, the histogram in this example is calculated in 16 segments for the luminance information or the difference information. The histogram is calculated for the luminance information or the difference information in 16 segments having thresholds. For example, in the case of extracting a histogram for the lowest luminance, it is determined that the video contains a large quantity of information having the lowest luminance or the lowest difference when histogram 0, among histograms 0 to 15, is high, and in the case of extracting a histogram for the highest luminance or the highest difference, it is determined that the video contains a large quantity of information having the highest luminance or the highest difference when histogram 15, among histograms 0 to 15, is high. For example, in the case where the luminance information has been selected by extracted component selector 236, the target video data is a black image video when information having the lowest luminance is contained in a large quantity, whereas the target video data is a white image video when information having the highest luminance is contained in a large quantity. Also, in the case where the difference information has been selected by extracted component selector 236, the target video data is a video of a color close to a predetermined specific color when information having the lowest difference is contained in a large quantity, whereas the target video data is a video of a color different from the predetermined specific color when information having the highest difference is contained in a large quantity.

When the above loop processing performed in units of frames is finished, anomaly detector 240 performs video anomaly detection (anomaly detection S204). Here, assuming that extracted component selector 236 has selected the difference information and that a video containing a large quantity of information having the lowest difference is an example of a video having an anomalous tendency, it is determined that a video having an anomalous tendency (that is, a specific color or a color close to a specific color) has been detected when the frequency of belonging to histogram 0, which is an example of a predetermined difference interval, is at least N % (a first threshold) of the histogram calculation result for the entire difference information (that is, all the frequencies) (Yes in S205), whereas it is determined that a video having an anomalous tendency (that is, a specific color or a color close to a specific color) was not detected when the frequency is less than N % (No in S205). Note that N for N % is a given integer, and is a variable value as the first threshold.

After the determination in the histogram calculation, when the case where the frequency is at least N % of the histogram calculation result (Yes in S205) continues for at least M frames in a row (M is an example of a second threshold) (Yes in S206), anomaly detector 240 determines that a video having an anomalous tendency is continuing (that is, a video anomaly is occurring) and notifies the outside that a video anomaly has occurred (S206a). On the other hand, when such a case continues for less than M frames (No in S206), the loop processing performed in units of frames is continued (200a through 200b). Note that M for M frames is a given integer and can be variable as a threshold.

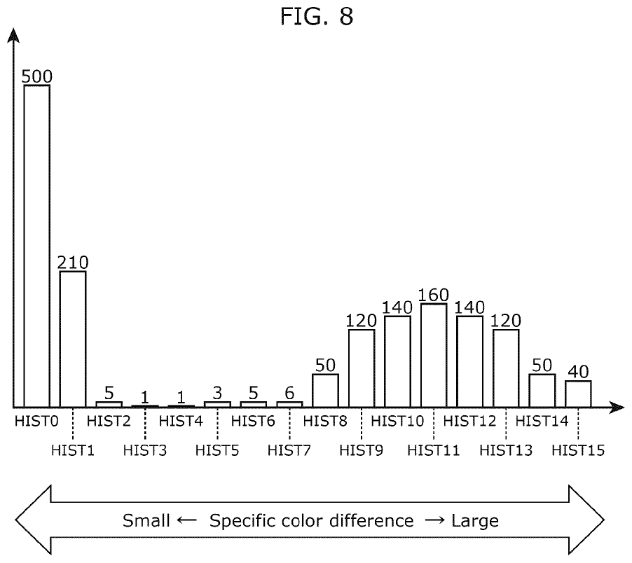

FIG. 8 is a conceptual diagram illustrating a histogram calculation method used by histogram calculator 233. Described here is an example in which the histogram is calculated in 16 segments. That is to say, the histogram is calculated in 16 segments having thresholds for the difference information with respect to a specific color of RGB or YUV (that is, a reference video) on the horizontal axis. For example, in the case of extracting a histogram having a small difference from the reference video, it is determined that the target video data is a video containing a large quantity of information having a small difference from the reference video when histogram 0, among histograms 0 to 15, indicates a frequency greater than or equal to a first threshold, whereas in the case of extracting a histogram having a large difference from the reference video, it is determined that the target video data is a video containing a large quantity of information having a large difference from the reference video when histogram 15, among histograms 0 to 15, indicates a frequency greater than or equal to the first threshold. That is to say, the video is a specific color video (that is, a video of a specific color or a color close to a specific color) when the difference from the reference video is small, and the video is a non-specific color video (that is, a video of a color not similar to a specific color) when the difference from the reference video is large.

Note that the histogram need not necessarily be calculated for the entire video monitoring region obtained by signal determiner 132, and may be calculated for only the ½, ¼, or ⅛ pixels of the video monitoring region. Also, although described above is an example in which the histogram has 16 segments on the horizontal axis, the histogram may have 24 or 32 segments for a higher detection precision.

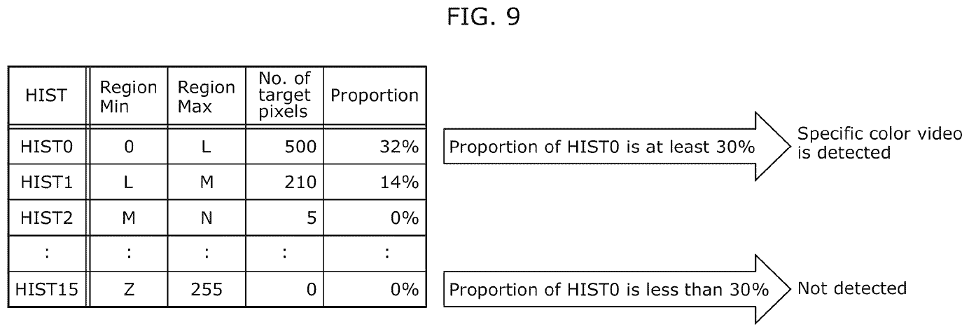

FIG. 9 is a conceptual diagram illustrating an anomaly detection method performed by anomaly detector 240. Described here is an example in which the histogram is calculated in 16 segments. The histogram obtained by histogram calculator 233 is put into a table (that is, categorized into HIST0 through HIST15 into which the luminance information is categorized according to “Region Min” to “Region Max”), and since histogram 0 (“HIST0”) occupies, for example, at least 30% (“32%” in the diagram), it is determined that the video contains a large quantity of information having a small difference from the reference video and that a specific color video has been detected.

Note that if histogram 15 (“HIST15”) occupies, for example, at least 30%, it is determined that the video contains a large quantity of information having a large difference from the reference video and that a non-specific color video has been detected. In the present embodiment, histogram 15 (“HIST15”) occupies 0%, and thus it is determined that a non-specific color video was not detected (“Not detected”).

After the determination in the histogram calculation, it is eventually determined that a specific color video is continuing (that is, a video anomaly is occurring) when the case where the proportion is at least 30% of the histogram calculation result continues for at least 10 frames in a row. Otherwise, the video is the non-specific color video, and the video monitoring is thus continued.

Note that in the present embodiment, it is determined that a video anomaly is occurring when frames containing many videos of a specific color or a color close to a specific color continue; however, the present disclosure is not limited to such a determination criterion. It may be conversely determined that a video anomaly is occurring when frames having a large difference from a specific color continue (that is, the video is a non-specific color video).

In addition, the threshold (the first threshold) for the anomaly determination need not necessarily be at least 30%, and may be variable according to the application.

In addition, the determination criterion for a video anomaly in the case of using the luminance information may be different from the determination criterion for a video anomaly in the case of using the specific color difference. For example, in the case of using the luminance information, it is determined, as in the embodiment, that a video anomaly is occurring when a total number of consecutive frames for which the frequency of belonging to histogram 0 is at least the first threshold, is at least the second threshold, whereas in the case of using the specific color difference, it may be determined, contrary to the embodiment, that a video anomaly is occurring when a total number of consecutive frames for which the frequency of belonging to histogram 0 is less than the first threshold, is at least the second threshold. With this, it is determined that a video anomaly is occurring when black image videos continue or when videos of a color different from a specific color continue.

An aspect of the video monitoring device has been described above based on a reference example and an embodiment; however, the aspect of the video monitoring device is not limited to the reference example and the embodiment. Modifications conceivable to a person skilled in the art may be made to the reference example and the embodiment, and a plurality of constituent elements in the reference example and the embodiment may be freely combined.

For example, a process executed by a particular constituent element in the embodiment may be executed by another constituent element instead of the particular constituent element. Also, the processing order of a plurality of processes may be changed, and a plurality of processes may be executed in parallel. In addition, a plurality of variations may be applied in combination.

Furthermore, a video monitoring method including steps performed by the constituent elements of the video monitoring device according to the embodiment may be executed by an arbitrary device or system. For example, the video monitoring method may be partially or entirely executed by a computer that includes, for example, a processor, a memory, and an input-output circuit. In doing so, the video monitoring method may be executed through execution, by a computer, of a program intended to cause a computer to execute the video monitoring method.

Also, the program may be recorded on a non-transitory computer-readable recording medium such as a compact disc read-only memory (CD-ROM).

Furthermore, each constituent element of the video monitoring device according to the embodiment may be configured as dedicated hardware, may be configured as general purpose hardware that executes the above program and so on, and may be configured as a combination of these. Also, the general purpose hardware may include, for example, a memory having a program recorded thereon and a general purpose processor that reads the program from the memory and executes the program. Here, the memory may be a semiconductor memory or a hard disk, for example, and the general purpose processor may be a CPU, for example.

In addition, the dedicated hardware may include a memory and a dedicated processor, for example. For example, the dedicated processor may refer to the memory on which data is recorded, and execute the above-described video monitoring method.

Furthermore, each constituent element of the video monitoring device according to the embodiment may be an electric circuit. These electric circuits may make up one electric circuit as a whole, or may be individual electric circuits. Also, these electric circuits may correspond to dedicated hardware, or may correspond to general purpose hardware that executes the above-described program and so on.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The present disclosure is useful as a video monitoring device, for example as a video monitoring device that monitors video data generated by a video processing device, and is applicable to, for example, a video monitoring device that monitors a video for an in-vehicle video processing device such as an in-vehicle head-up display.

1. A video monitoring device that monitors video data received from a video display device that receives a video signal from a camera and displays a video, the video monitoring device comprising:
a video extractor that extracts, from the video data received, color information of each of pixels included in an image indicated by the video data;
a specific color difference operator that computes, for each of the pixels, difference information indicating a difference between a color indicated by the color information extracted and a specific color that is predetermined;
a histogram calculator that calculates a histogram by classifying the difference information computed for each of the pixels, the histogram having, for each of a plurality of difference intervals, a frequency indicating a total number of pixels that belong to the difference interval; and
an anomaly detector that generates and outputs a signal indicating that the video data is anomalous, when a frequency of belonging to a predetermined difference interval in the histogram calculated is at least a first threshold.

2. The video monitoring device according to claim 1, further comprising:
a signal determiner that determines, for each of the pixels, whether the pixel belongs to a video monitoring region that is a region to be monitored, wherein
the histogram calculator calculates the histogram for a pixel determined by the signal determiner to belong to the video monitoring region.

3. The video monitoring device according to claim 1, further comprising:
a luminance extractor that extracts, from the video data received, luminance information of each of the pixels included in the image indicated by the video data; and
an extracted component selector that selects the luminance information extracted by the luminance extractor or the difference information computed by the specific color difference operator, wherein
the histogram calculator calculates the histogram based on the luminance information or the difference information selected by the extracted component selector.

4. The video monitoring device according to claim 1, wherein
the video data includes, for each of the pixels, data items on RGB or YUV components,
the specific color includes data items on RGB or YUV components, and
the specific color difference operator takes a difference between the video data and the specific color, for each of the data items on RGB or YUV components.

5. The video monitoring device according to claim 2, wherein
the signal determiner determines, for each of the pixels, whether the pixel belongs to the video monitoring region, by using an intermediate video data item selected from among a plurality of intermediate video data items generated in a process of generating the video data on a path from the camera to the video display device.

6. The video monitoring device according to claim 1, wherein
the histogram calculator has a plurality of first thresholds each being the first threshold, and calculates the histogram based on a first threshold selected from among the plurality of first thresholds.

7. The video monitoring device according to claim 1, wherein
the video data is a moving image, and
the anomaly detector determines, for each of frames included in the moving image, whether the frequency of belonging to the predetermined difference interval in the histogram is at least the first threshold, and generates and outputs a signal indicating that the video data is anomalous when a total number of consecutive frames for which the frequency of belonging to the predetermined difference interval in the histogram is determined to be at least the first threshold, is at least a second threshold.

8. The video monitoring device according to claim 7, wherein
the second threshold is a variable value.

9. A video monitoring method for monitoring video data received from a video display device that receives a video signal from a camera and displays a video, the video monitoring method comprising:
extracting, from the video data received, color information of each of pixels included in an image indicated by the video data;
computing, for each of the pixels, difference information indicating a difference between a color indicated by the color information extracted and a specific color that is predetermined;
calculating a histogram by classifying the difference information computed for each of the pixels, the histogram having, for each of a plurality of difference intervals, a frequency indicating a total number of pixels that belong to the difference interval; and
generating and outputting a signal indicating that the video data is anomalous, when a frequency of belonging to a predetermined difference interval in the histogram calculated is at least a first threshold.
